(19) United States
(12) Patent Application Publication
(10) Pub. No.: US 2025/0243988 A1
(43) Pub. Date: Jul. 31, 2025

(54) LENS AND LUMINAIRE

(71) Applicant: ABL IP Holding LLC, Atlanta, GA (US)

(72) Inventors: Qi AI, Suwanee, GA (US); Jianyong XU, Shenzhen City (CN); Zhigang HE, Shenzhen City (CN)

(21) Appl. No.: 19/040,134

(22) Filed: Jan. 29, 2025

Related U.S. Application Data
(63) Continuation-in-part of application No. 18/670,404, filed on May 21, 2024.

(30) Foreign Application Priority Data
Jan. 29, 2024 (CN) 202420211377.0

(51) Int. Cl. F21V 5/04; F21Y 115/10

(52) U.S. Cl. CPC F21V 5/045; F21Y 2115/10

(57) ABSTRACT

A lens configured to cover light sources. The lens includes a first surface including a plurality of light diffusing features protruding from the first surface to a side of the light sources, and a second surface opposite to the first surface and arranged away from the light sources. The second surface includes a plurality of light shaping features protruding outwardly from the second surface away from or curved inwardly towards the first surface. The light diffusing features are adapted to diffuse light incident on the first surface. The light shaping features are adapted to shape the diffused light before being directed towards the outside.

### CROSS-REFERENCE TO RELATED APPLICATION

The present application is a continuation-in-part of U.S. patent application Ser. No. 18/670,404, filed on May 21, 2024, which claims the benefit of priority from Chinese Patent Application No. 202420211377.0 entitled “TRANSPARENT COVER PLATE” and filed on Jan. 29, 2024, the contents of both are incorporated by reference in its entire by reference.

### BACKGROUND

### Technical Field

The present disclosure generally relates to the field of lenses, and especially relates to lenses and luminaires.

### Description of Related Art

A lens is an optical element made of a transparent material, which is made according to a refraction principle of light and is usually installed over a light source. The lens is configured to create different lighting effects or light distributions.

A lens can be a refracting mirror that typically has two surfaces. The lenses on the market mainly include three types: a double-concave lens, a flat-concave lens, and a convex-concave lens. The double-concave lens has two concave surfaces, the flat-concave lens has a flat surface and a concave surface, and the convex-concave lens has a concave surface and a convex surface.

The two surfaces of a commonly used lens are either convex or concave as a whole. Such a lens has the same focal point, without having a mixing effect. As a result, a transmitted light spot is uneven and prone to color differences (e.g., warmer color, cooler color with regard to the Correlated Color Temperature (CCT) of LED), and may not meet anti-glare specifications such as Unified Glare Rating (UGR) requirements. Hence, improved lenses are needed.

### SUMMARY

The present disclosure provides a lens comprising light scattering and light shaping members to create specified light distributions while providing improved anti-glare characteristics compared to existing lenses. In some embodiments, a lens includes a first surface and an opposing second surface. The first surface includes a plurality of light diffusing features that protrude outwardly from the first surface in a direction away from the second surface. The plurality of light diffusing features is adapted to diffuse light incident on the first surface to create diffused light. The second surface includes a plurality of light shaping features protruding outwardly from the second surface in a direction away from the first surface and adapted to receive and shape the diffused light such that a desired light distribution exits the lens.

In some embodiments, a luminaire includes a light board having a plurality of light sources, and a lens optically coupled to the light board. The lens includes a first surface and a second surface. The first surface faces the light board and includes a plurality of light diffusing features protruding towards the light board. The plurality of light diffusing features is adapted to diffuse light received from the plurality of light sources. The second surface is opposite to the first surface and faces away from the light board. The second surface includes a plurality of discrete light shaping features protruding outwardly away from the side of the light board. The plurality of discrete light shaping features are adapted to shape the diffused light such that the diffused light exits the lens in a desired distribution.

The lens herein provides several advantages. For example, the light diffusing features of the lens can be used to scatter light for light mixing treatment. The scattered and mixed light can then be shaped (e.g., converged and/or diverged) through the plurality of light shaping features to form a desired light distribution without color separation and meet anti-glare requirements for transmission to the outside.

### BRIEF DESCRIPTION OF THE DRAWINGS

In order to more clearly understand the technical solution hereinafter in embodiments of the present disclosure, a brief description to the drawings used in detailed description of embodiments hereinafter is provided thereof. Obviously, the drawings described below are some embodiments of the present disclosure, for one of ordinary skill in the related art, other drawings can be obtained according to the drawings below on the premise of no creative work.

FIG. 1 is a perspective view illustrating an outer surface of a lens in accordance with an embodiment of the present disclosure.

FIG. 2 is a perspective view illustrating an inner surface of the lens of FIG. 1.

FIG. 3 is a cross-sectional view of the lens of FIG. 1.

FIG. 4 is a partial enlarged view of a circled portion A of the lens in FIG. 3.

FIG. 5 illustrates a simplified example of a ray diagram associated with the lens of FIG. 1.

FIG. 6 is a partial enlarged view of a circled portion B of the lens in FIG. 1.

FIG. 7 is a partial enlarged view of a circled portion C of the lens in FIG. 2.

FIG. 8 illustrates a luminaire in accordance with an embodiment of the present disclosure.

FIG. 9 is an exploded view of the luminaire of FIG. 8.

FIG. 10 illustrates a heat sink of the luminaire of FIG. 8.

FIG. 11 illustrates an example ray tracing through the lens of FIG. 1 and FIG. 2.

FIG. 12 is a schematic view of light passing through a light-emitting surface of the lens of FIG. 1 and FIG. 2.

FIG. 13A illustrates a cross-section showing a first curvature of a light shaping feature of the lens of FIG. 1 and FIG. 2.

FIG. 13B illustrates a cross-section showing a second curvature of a light shaping feature of the lens of FIG. 1 and FIG. 2.

FIG. 13C illustrates a cross-section showing a third curvature of a light shaping feature of the lens of FIG. 1 and FIG. 2.

The element labels according to the embodiment of the present disclosure shown as below:
10 lens, 100 lens body, 100d middle portion, 11 first surface, 111 astigmatic members or light diffusing features, 111a light-entering surface, 12 second surface, 121 convergent light members or light shaping features, 121a light-emitting surface, 122 first gap, 123 second gap, 13 coupling features, 131 first installation hole, 150 light source, 20 power box, 30 heat sink, 31 receiving space, 32 seat, 321 second installation hole, 30e middle section, 40 LED light board, 41 board body, 42 light bead/LED, 43 third gap, 44 fourth gap, 45 fifth gap, 50 frame, 60 dimming radar, 70 hook, 101 first body, 102 second body, L axis.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. Obviously, the implementation embodiment in the description is a part of the present disclosure implementation examples, rather than the implementation of all embodiments, examples. According to the described exemplary embodiment of the present disclosure, all other embodiments obtained by one of ordinary skill in the related art on the premise of no creative work are within the protection scope of the present disclosure.

It should also be understood that the terms used in the specification of the present disclosure are only for the purpose of describing specific embodiments without being intended to limit the present disclosure. As used in the description of the present disclosure and the appended claims, terms of “one”, “one” and “the” in a singular form are intended to include a plural form unless the context clearly indicates otherwise.

It should also be further understood that the term “and/or” used in the description of the present disclosure and the appended claims refers to any combination of one or more of associated listed items and all possible combinations, and includes these combinations.

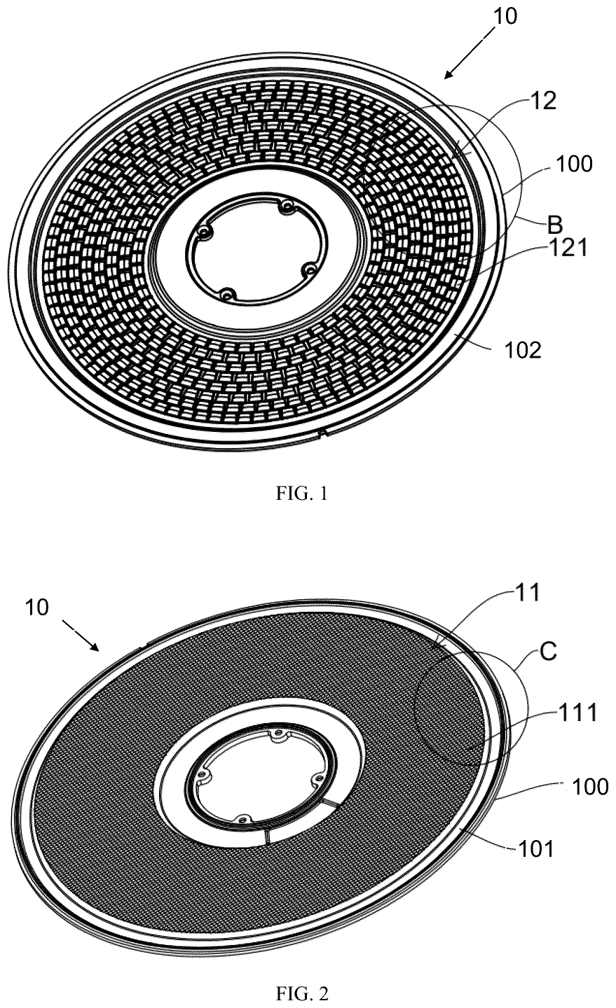

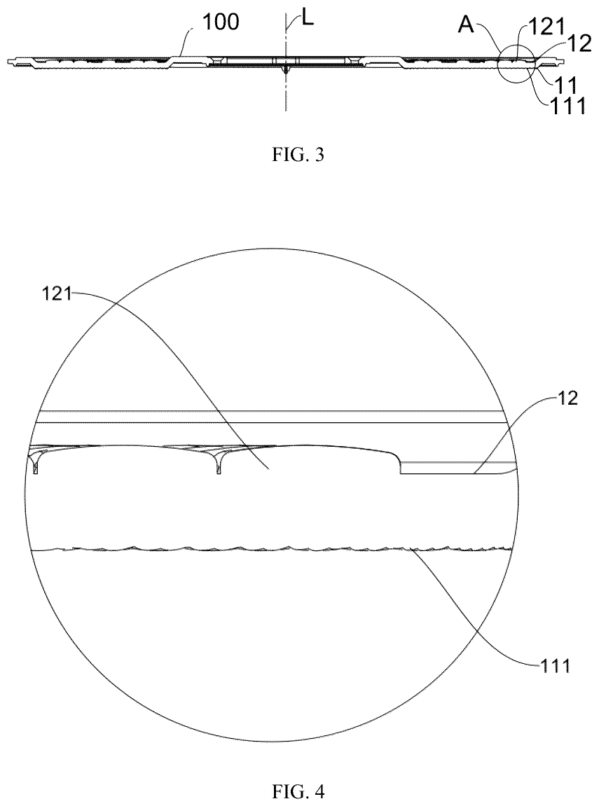

FIGS. 1-7 illustrate a lens 10 that can be used in conjunction with one or more light sources 150, according to various embodiments. In some embodiments, the light sources 150 can be light emitting diodes (LEDs, but the lens 10 may be used with other light sources.

The lens 10 can include a lens body 100 having a first body 101 and a second body 102. In an embodiment of the present disclosure, the first body 101 is integrated with (e.g., formed integrally with) the second body 102. In other words, the lens body 100 can have a unitary construction. In other embodiments, the first body 101 is assembled to the second body 102. In other words, the first body 101 and the second body 102 can be two separate elements that are attached to each other to form the lens 100. For example, the first body 101 and the second body 102 can be attached using adhesive, fusing edges together by heat treatment, fasteners, or other appropriate coupling mechanisms used for joining optical components. The lens body 100 can extend in a plane (i.e., be flat, as illustrated in the Figures) or alternatively can be a curved body.

The first body 101 can include a first surface 11 and a plurality of light diffusing features 111. The second body 102 can include a second surface 12 and a plurality of light shaping features 121. The first surface 11 is opposite to the second surface 12 and arranged more proximate the light sources 150 in situ. The second surface 12 is arranged to face away from the light sources 150 in situ. The plurality of light diffusing features 111 protrudes from the first surface 11 toward the light sources 150. The plurality of light shaping features 121 protrude outwardly from the second surface 12 away from the light sources 150. The plurality of light diffusing features 111 cause the light emitted from the light sources 150 to spread, thereby obscuring the sources of light. For example, the light sources 150 may be include light sources arranged in concentric rings or other patterns. These rings or patterns, and related sources, may be visible through existing lens. The lens 10 herein may be designed to obscure the nature of the light sources and obscure the ring or other pattern of the light sources 150 to create a uniform appearance on the lens from below when the light sources 150 are activated.

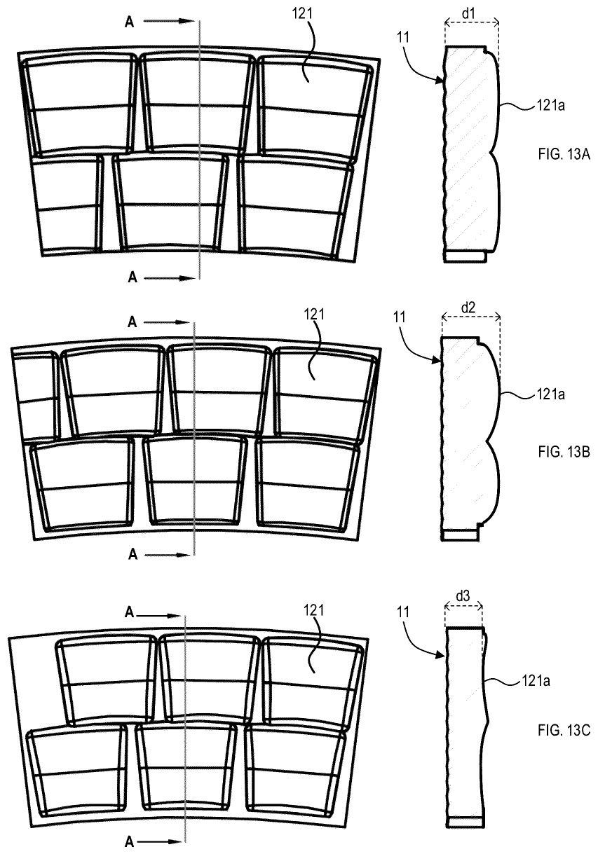

The plurality of light shaping features 121 shape the light to create a specified light distribution from the lens 10. In some embodiments, the geometry of the light shaping features 121 is designed to converge the light to different extents to thereby create different distributions (e.g., to achieve narrow, medium, and/or wide distributions). In all embodiments, the light shaping features 121 have a curved light exiting surface (e.g., 121a). The curved light exiting surface (e.g., 121a) can be a freeform surface. In some embodiments, see FIGS. 13A and 13B, the curved light exiting surface (e.g., 121a) curves or bulges away from the first surface 11 or the light sources 150. In this way, the light shaping features 121 converge the light exiting the lens 10 to reduce high angle light and thereby reduce resulting glare. For example, in some embodiments the lens 10 achieves a Unified Glare Rating (UGR) of less than 28 for narrow and medium distributions. In some embodiments, see FIG. 13C, the curved light exiting surface (e.g., 121a) curve toward the first surface 11 or the light sources 150 to spread/diverge the light and create a wide distribution. The lens 10 achieves a UGR of less than 32 for wide distributions.

The degree of the curvature or bulge of the light exiting surface (e.g., 121a) of the light shaping features 121 impacts the degree of convergence of the exiting light and thus the resulting distribution. The degree or extent of curvature can be characterized as a maximum distance measured from a base of the light shaping feature 121, a radius of curvature, or other parameters characterizing a bulge or a curvature. For example, the greater the bulge, the more light convergence and thus the narrower the distribution. Thus, the curved light exiting surface (e.g., 121a) for a narrow distribution (ND) bulges more than the curved light exiting surface for a medium distribution (MD). As shown in FIG. 13A, a first degree of curvature can be characterized by a first distance d1 of the curved surface 121a from the first surface 11. As shown in FIG. 13B, a second degree of curvature can be characterized by a second distance d2 of the curved surface 121a from the first surface 11. The second distance d2 is more than the first distance d1 thereby the curved surface 121a in FIG. 13B creates a narrower distribution than the curved surface 121a in FIG. 13B. As shown in FIG. 13C, a third curvature can be characterized by a third distance d3 of the curved surface 121a from the first surface 11. The curved surface 121a is curved inwardly toward the first surface 11 thereby creating a wider distribution than created by the light shaping features of FIGS. 13A and 13B. In some embodiments, the light distribution ND/MD/WD from a fixture impacts the desired spacing between adjacent luminaires in an installation.

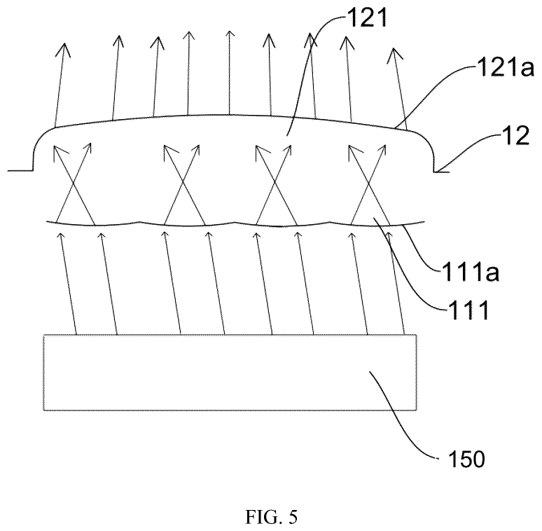

Referring to FIG. 5 and FIGS. 11-12, the plurality of light diffusing features 111 are arranged on the first surface 11 of the lens body 100. The plurality of light shaping features 121 are arranged on the second surface 12. The light emitted from the light sources 150 first passes through the plurality of light diffusing features 111, which spread, scatter or diffuse the light from the light sources and mix the light to obscure the source nature of the light. The mixing of the light can prevent a color separation that may appear in an output light distribution projecting on a target area. For example, color emitted from an LED can vary as a function of the angle of emitted light and is referred to as the color-over-angle (CoA) effect. The CoA effect may lead to color rings (e.g., yellow rings) at large angles in the far-field of a white LED, for example. The light diffusing features 111 mitigate the CoA effect by mixing the cooler and warmer light together so that the light being sent to a target plane can have uniform color (e.g., having negligible to no visible color separation).

The plurality of light diffusing features 111 can form a textured surface facing towards the side of the light sources 150. In some embodiments, the plurality of light diffusing features 111 may include protrusions that are spread across the entire first surface 11. In some embodiments, the plurality of light diffusing features may spread across only portions of the first surface 11 and are positioned in locations that correspond to the locations of the light sources 150. In some embodiments, the light diffusing features 111 may be formed on a curved surface facing towards the side of the light sources 150. Accordingly, the first surface 11 may be curved or dome shaped. In some embodiments, the light diffusing features 111 may be formed on a flat surface facing towards the side of the light sources 150. Accordingly, the first surface 11 may be a flat textured surface. In some embodiments, the first surface 11 may not include textures for spreading light. In this case, the whole lens can be manufactured as a volumetric diffusing lens. A volumetric diffusing lens is made of optically clear resin mixed with a diffusant resin. The volumetric diffusing lens can appear milkier. The diffusant resin mixed with the clear resin scatters light thus mixing or diffusing within inside the lens. The light diffusing features 111 or the volumetric diffusing lens can be configured to mitigate the CoA effect and reduce the LED pixelation effect. For example, LED pixelation effect refers to visible separation between LEDs creating a pixelated appearance.

As shown in FIG. 5, the light emitted from the light sources 150 will be refracted by the plurality of light diffusing features 111 and mixed together while propagating through the lens body 100 towards the plurality of light shaping features 121. For example, the light emitted from the light sources 150 will be refracted and scattered by the plurality of light diffusing features 111 and mixed within a portion of the lens body 100 between the plurality of light diffusing features 111 and the plurality of light diffusing features 111. As a result, the light appears uniform without color separations thereof.

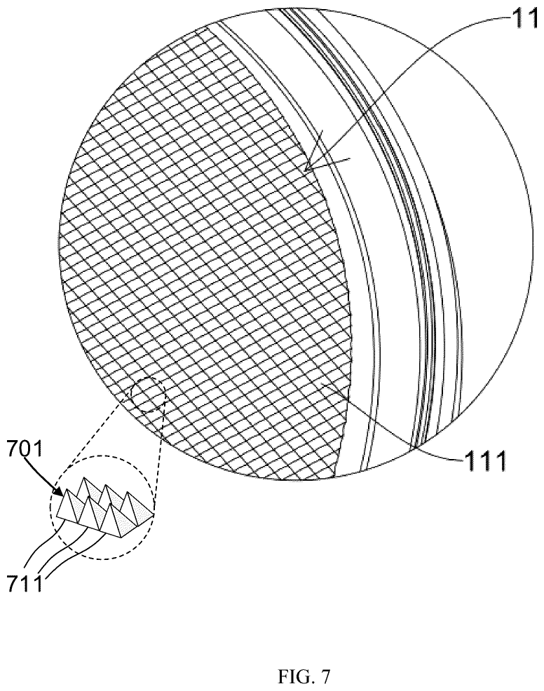

Referring to FIG. 2 and FIG. 7, the plurality of light diffusing features 111 may be arranged on the first surface 11 to create a texturized first surface 11 to diffuse the light. The plurality of light diffusing features 111 can be arranged in an array in a desired pattern. In the illustrated embodiment, the light diffusing features 111 are uniformly arranged in a matrix having aligned rows and columns. For example, adjacent rows of light diffusing features 111 of the plurality of light diffusing features 111 in the matrix abut against each other. Adjacent light diffusing features 111 in the same row abut against each other. Because adjacent rows of light diffusing features 111 of the plurality of light diffusing features 111 in the matrix abut against each other and adjacent light diffusing features 111 in the same row abut against each other, there is no gap formed between adjacent rows of light diffusing features 111 of the plurality of light diffusing features 111 in the matrix, and there is no gap formed between adjacent light diffusing features 111 in the same row. Rather, a continuous texturized surface is provided. However, the matrix arrangement is shown as an example and other arrangements or patterns of the light diffusing features 111 on the first surface 11 are contemplated. For example, the light diffusing features 111 may be arranged in a discrete manner, where the light diffusing features 111 are not abutting (e.g., at the base) but may include gaps therebetween. In some embodiments, clusters of light diffusing features 111 may be formed, each cluster covering a projected area of a single light shaping feature 121. In some embodiments, the light diffusing features may be formed in a circular or other pattern that corresponds to the pattern of the light shaping features 121.

The light diffusing features 111 can have a variety of different geometries. In the embodiment shown in FIG. 7, the light diffusing features 111 are four-sided prisms 701 that extend from a square base and have apexes directed toward the light sources 150. However, prisms of any geometry are contemplated. For example, the light diffusing features 111 could be prisms having any number of sides (three, four, etc.) extending from any rectilinear-shaped base (e.g., square, rectangle, etc.). Moreover, the light diffusing features 111 need not be prisms but may be cone-shaped, semi-spherical-shaped, or merely formed as convex curves relative to the light sources 150. In still other embodiments, the light diffusing features 111 may be provided as ridges that extend in continuous rows across the first surface 11. The geometry, spacing, etc. of the light diffusing features 111 may not be the same but instead may vary across the first surface 11.

The light diffusing features 111 may be provided in any density on the first surface 11. The light diffusing features 111 can be smaller than one-third, one-fifth, or less the size of a light emitting surface (LES) associated with an individual LED. In some embodiments, the light diffusing features 111 associated with each individual LED can be characterized by density per unit area or per light receiving surface area. For example, a number of light diffusing features 111 per unit area or per LES can be five or more, six or more, or other higher number. In some embodiments, the total area of the plurality of light diffusing features 111 covering the first surface 11 is approximately the same as an area covered by the plurality of light shaping features 121 on the second surface 12. In some embodiments, the total area of the plurality of light diffusing features 111 covering the first surface 11 is approximately 110% of the total area of the LED light emitting surfaces so that all of the light emitted by the LEDs passes through the diffusing features 111 before the light travels to the light shaping features 121.

Each light diffusing feature 111 can include a light-entering surface 111a arranged on the side proximate the light sources 150 and directly facing the light sources 150. The light-entering surface 111a can include a curved and/or textured surface protruding towards the side of the light sources 150. As the light diffusing features 111 are raised features protruding towards the side of the light sources 150, the light emitted by the light sources 150 will be refracted through the light-entering surfaces 111a of the light diffusing features 111 and propagate towards the light shaping features 121, which re-aggregate or shape the light to create the desired distribution.

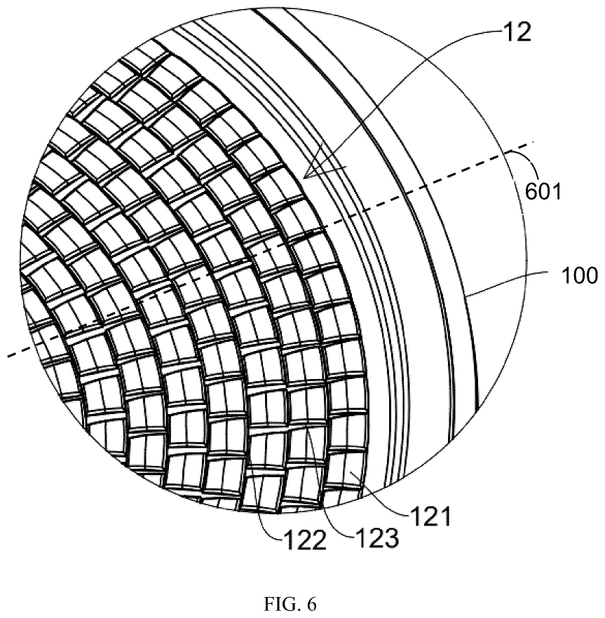

Referring to FIG. 6, in some embodiments, each light shaping feature 121 of the plurality of light shaping features 121 can be a lens with a curved surface relative to the light sources 150 (e.g., extending in a direction away from or towards the light sources 150). Each of the plurality of light shaping features 121 can be a discrete, standalone optic formed as an individual lens or individual optic unit. Each discrete optic of the light shaping features 121 can be bounded by a perimeter (e.g., perimeter of a base). In some embodiment, the discrete optics include a base from which, or above which, the curved surface extends (either concavely or convexly relative to the base). In some embodiments, the plurality of light shaping features 121 can be spaced from each other. In some embodiments, see FIGS. 13A-13C, portions of the bases of adjacent light shaping features 121 may touch or contact each other. Although not illustrated, it can be appreciated that the bases of adjacent light shaping features 121 may be spaced from each other such that no portion of the bases touch each other.

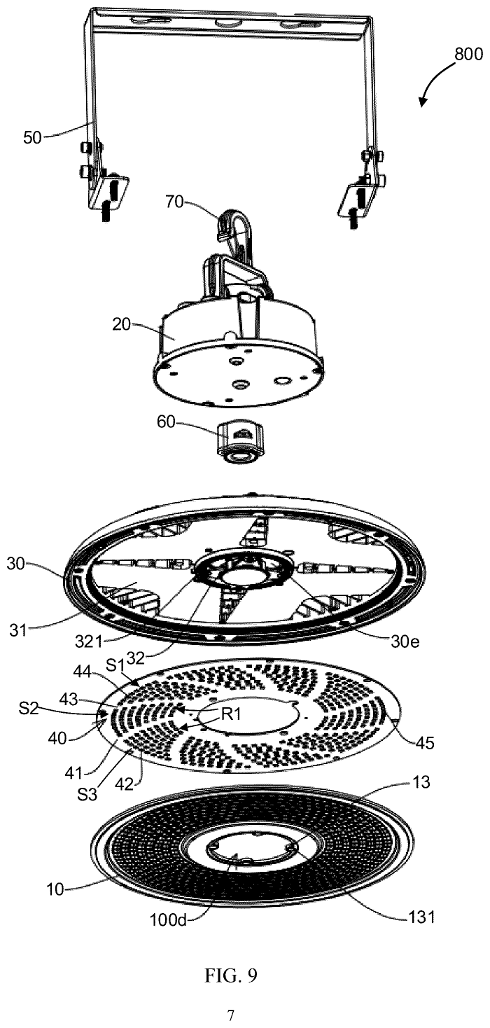

Depending on a position and orientation of each lens 121, a focal point of each light shaping feature 121 can be different. Each lens can have a focal point that is not in a single spatial location relative to the lens 10. Each light shaping feature 121 can be positioned to overlie a single light source (e.g., an LED of the LED light board 40 in FIG. 9). As the focal point of each light shaping features 121 can be different relative to the lens 10, the point nature of the light sources 150 can be obscured so that the light emitted from the lens 10 appears uniform. For example, when the lens 10 is viewed from below, no high intensity light spots, ring patterns, or other patterns that betray the position of the light sources 150 are visible on the lens 10.

In an embodiment of the present disclosure, referring to FIG. 1, FIG. 3 and FIG. 6, the plurality of light shaping features 121 can be arranged on the second surface 12 in a circular pattern (i.e., in concentric rings) around an axis L (see FIG. 3) of the lens body 100, with a center point of each ring being the same (i.e., axis L). A radius of the ring closest to the axis L of the lens body 10 is the smallest, and then radiuses of the rings increase gradually from the axis L in a direction away from the axis L. The circular pattern is illustrated as an example without limiting the scope of the present disclosure. Other patterns or arrangements of the light shaping features 121 are possible.

The plurality of light shaping features 121 can be a staggered (e.g., offset) relative to each other around the axis L of the lens body 100. As shown in FIG. 6, each light shaping feature 121 can have a lens axis passing through its center. The light shaping features 121 can be arranged such that the lens axis or center point of each light shaping feature 121 is offset from that of the one or more light shaping feature 121 radially adjacent it in an adjacent ring. For example, the offset or misalignment between the lens axes of the light shaping features 121 can be visualized using a line 601 (e.g., a radius) passing through a center of the lens 10. As seen in FIG. 6, the center points of each lens 121 along the line 601 do not align with or pass through the line 601. The center points of each lens 121 can be offset from the line 601 by different amounts.

The light shaping features 121 can be positioned relative to the light sources 150 such that there is a one-to-one correspondence between the light shaping features 121 and the light sources 150. Furthermore, the optical axis of each of the light sources 150 can be aligned with or pass through the center or lens axis of a corresponding light shaping feature 121. However, the present disclosure is not limited to one-to-one correspondence between the features 121 and the light sources 150. In some embodiments, two or more of the light sources 150 (e.g., LEDs) can be densely packed together in a cluster and individual light shaping feature 121 can be sized to span or overlie the cluster of two or more light sources. Furthermore, in some embodiments, each of the light shaping features 121 may be offset relative to the optical axis of corresponding one of the light sources 150, The staggered or offset arrangement of the light shaping features 121 between adjacent rings obscures, or prevents visibility of, the arrangement or pattern (e.g., rings, fan-shaped or spiral) of the light sources 150 behind the lens 10 when the light sources 150 are activated. As a result, a more uniform light output is achieved by the lens 10 compared to existing lenses.

In the illustrated embodiment, see FIG. 6, a first gap 122 can be formed between adjacent rings of the light shaping features 121, and a second gap 123 can be formed between two adjacent light shaping features 121 of the same ring. In an embodiment of the present disclosure, as shown in FIG. 6, a width of the first gap 122 may be smaller than a width of the second gap 123 but such is not a requirement. Gaps 122, 123 create discrete light shaping features 121 such that each light shaping feature 121 covers a correspondingly located LED. However, in other embodiments, the light shaping features 121 may not discrete b+ut provided in continuous optic rings.

In an embodiment of the present disclosure, the number of light diffusing features 111 is greater than the number of light shaping features 121 such that each light shaping feature 121 is sized and positioned to receive light from a plurality of light diffusing features 111. For example, in a plan view, one light shaping feature 121 overlies a plurality of light diffusing features 111. Each light diffusing feature 111 can be smaller than each of the light shaping features 121. In some embodiments, the size or footprint of each light diffusing feature 111 is less than one-third the size or footprint of the light shaping feature 121.

Each light shaping feature 121 includes a curved light emitting surface 121a that bulges or protrudes outwardly from the side of the lens 10 facing away from the light sources 150 (the second surface 12). Each light shaping feature 121 has a base. While the light shaping features 121 shown in FIG. 6 have a trapezoidal-shaped base, the light shaping features 121 can have a base of any shape, including, but not limited to, circular, oval, rectangular, square, regular polygon, or other shapes. The light passing through the lens body 100 passes through the light-emitting surfaces 121a to be shaped. As discussed above, the degree of the bulge or curvature of the light emitting surface 121a of the light shaping features 121 dictates the light distribution from the lens 10 (e.g., ND, MD, WD).

In some embodiments, referring to FIG. 1 and FIG. 6, the lens body 100 can be circular or disc-shaped and the plurality of light shaping features 121 uniformly arranged in concentric rings around the axis L of the lens body 100. However, the present disclosure is not limited to circular or disc-shaped lens body 100 and other shapes are possible. For example, the shape of the lens body 100 can be rectilinear (square, rectangle, etc.), triangular, oval, or any other geometric shape with the plurality of light shaping features 121 arranged in patterns that correspond or that do not correspond to the shape of the lens body 100.

In some embodiments, the lens 10 can be made from polycarbonate (PC), silicone, PMMA or other moldable material. In some embodiments, knurling tools using diamond bits, molding, or other optical manufacturing process can be used to create patterns that diffuse light incident on the light-entering surface 111a.

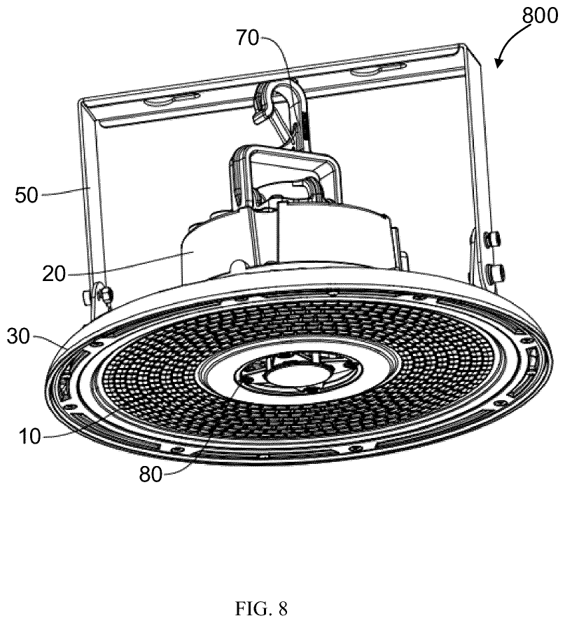

FIG. 8 to FIG. 10 illustrate a luminaire 800, according to an embodiment. As an example, the luminaire 800 can be an LED lamp. The luminaire 800 can include a power box 20, a heat sink 30, an LED light board 40, a frame 50 and a lens 10 (having features as discussed above). The frame 50 and the power box 20 can be fixedly connected to the heat sink 30. The LED light board 40 and the lens 10 can be sequentially installed on the heat sink 30. The frame 50 can be configured to fix the luminaire 800 to the outside, and a specific fixing method can be using screws 80 to fix the frame 50. However, the lens 10 disclosed herein may be used in any type of luminaire 800 and is not limited for use in the specific luminaire disclosed herein.

As shown in FIG. 9, the LED light board 40 includes a board body 41 with a circular ring shape, and a plurality of LEDs 42. The LEDs 42 can be strategically positioned on the board body 41 to complement the geometry of the lens 10 (or vice versa). While the LEDs may be positioned continuously across the board body 41, in some embodiments the LEDs are provided in a plurality of discrete LED sections e.g., S1, S2, S3. In some embodiments, the LED sections S1, S2, S3 have a fan-shape or spiral shape layout but such is not a requirement. For example, in a fan-shaped or spiral layout, the LEDs within a section (e.g., S1) are not aligned to each other along a radial direction. A third gap 43 can be formed between adjacent LED sections (e.g., S1 and S2). A fourth gap 44 can be formed between adjacent rows of LEDs 42 within the same LED section (e.g., S1). A fifth gap 45 can be formed between adjacent LEDs 42 in the same row within a LED section portion. In an embodiment of the present disclosure, a width of the third gap 43 is greater than a width of the fourth gap 44, and the width of the fourth gap 44 is greater than that of the fifth gap 45. But such is not a requirement.

An area occupied by the plurality of LEDs 42 on the board body 41 can be substantially the same as an area occupied by the plurality of light shaping features 121 on the second surface 12 of lens 10. Accordingly, the light shaping features 121 can be formed in the lens 10 based on the location and layout of the LEDs 42 (or vice versa). The fan shaped layout of the LEDs 42 is one example layout and other patterns or layouts (e.g., circular, non-uniform staggering, etc.) of the LEDs 42 are possible. In some embodiments, each LED 42 corresponds to a light shaping feature 121. In some embodiments, there is a 1:1 correspondence between an LED 42 and a light shaping feature 121.

In an embodiment of the present disclosure, the arrangement and quantity of LEDs 42 within an LED section (S1, S2, etc.) are the same. The LEDs 42 in the same row of each LED section form a circle (albeit one interrupted by third gaps 43), with a center of the formed circle being the same as that of the board body 41. For example, a first row R1 of LEDs 42 in a first LED section S1, together with the first row R1 of LEDs 42 in a second LED section S2, and the first row of LEDs 42 in a n-th LED section, cooperatively form a first circle, and so on. An m-th row of LEDs 42 in the first LED section (e.g., S1), together with the m-th row of LEDs 42 in the second LED section (e.g., S2), and the m-th row of LEDs 42 in the n-th LED section, cooperatively form an m-th circle. A radius of the first circle is the smallest, a radius of the m-th circle is the largest, and the radius from the first circle to the m-th circle increases sequentially.

In some embodiments, the arrangement of the plurality of LEDs 42 can better spread the light emitted from the light sources 150 by the plurality of light diffusing features 111. For example, a fan-shaped arrangement of LEDs 42 can be better spread compared to a uniform ring-shaped arrangement of LEDs (e.g., where LEDs are aligned to each other along a radius line). However, the present disclosure is not limited to a particular arrangement of LEDs 42, and the lens 10 can perform well in terms of anti-glare and uniform light output with different arrangements of LEDs 42.

The heat sink 30 includes a receiving space 31 for receiving the LED light board 40 therein. The lens 10 can cover the LED light board 40. The light emitted from the LED light board 40 passes through the lens 10 that in turn emits the light uniformly and in a desired distribution while reducing high angle light leading to glare.

In the illustrated embodiment, see FIG. 9, the lens 10 is circular to be compatible with the LED light board 40. The lens 10 can be formed as other compatible shapes according to the LED light board 40, such as a square, rectangle, or oval. A plurality of coupling features 13 can be arranged at a middle portion 100d of the lens 10. The middle portion 100d can be an aperture and the coupling features 13 can be arranged along a perimeter of the aperture. A seat 32 can be provided at a middle section 30e of the heat sink 30. The seat 32 can pass through the LED light board 40 and the lens 10. As an example, each of the plurality of coupling features 13 can include a first installation hole 131. The seat 32 can include a plurality of second installation holes 321. The lens 10 can be coupled to the heat sink 30 by threading screws through the first installation hole 131 and the plurality of second installation holes 321. In the illustrated embodiment, see FIG. 9, there are four seats 32 evenly arranged around the axis L of the lens 10. Each first installation hole 131 has a corresponding second installation hole 321. Additionally or alternatively, the luminaire 800 can further include a hook 70 installed on the power box 20, and configured to hang the LED lamp. The embodiment of the present disclosure is applicable to vertical lighting situations, when a vertical lighting is needed, the hook 70 of the present disclosure can be directly hung on a hook for being used.

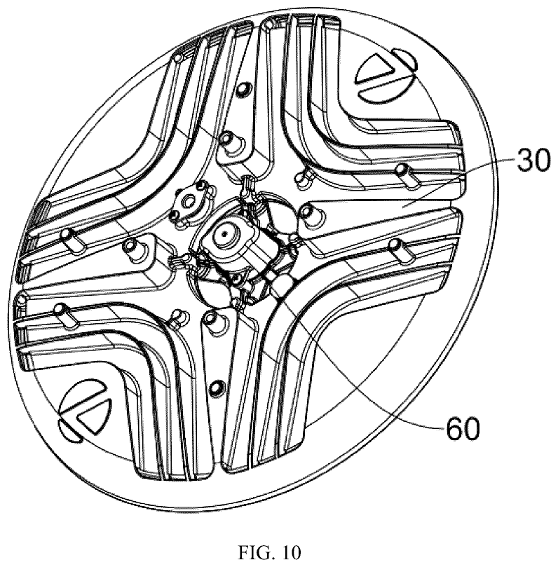

Additionally or alternatively, the luminaire 800 can include a dimming module 60 installed on the heat sink 30, as shown in FIGS. 9 and 10. The dimming module 60 can be arranged directly at the center of the lens 10. The dimming module 60 is arranged at a side of the seat 32 far from the lens 10 and configured to adjust light intensity to implement accurate light adjustment.

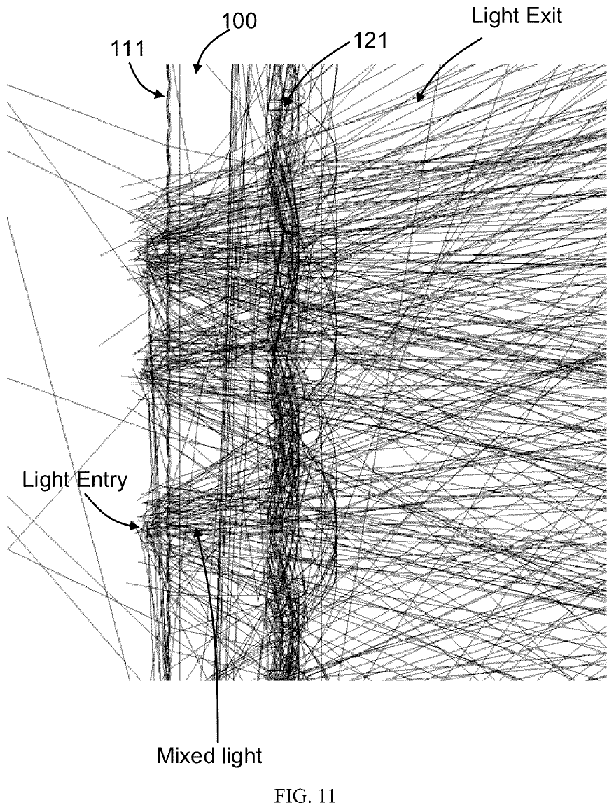

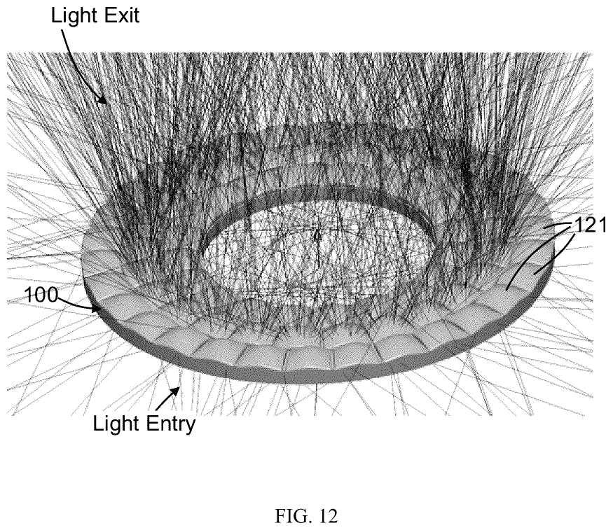

FIGS. 11 and 12 illustrates an example ray tracing through the lens 10. As shown, light emitted from the light sources is received by the first surface 111 having the light diffusing features 111a (best seen in FIG. 7). The light diffusing features 111a scatter the light causing the light to mix within a middle portion of the lens 100. The mixed light is then passed through the light shaping features 121a (best seen in FIG. 6) on the second surface 121. As a result, light exits the lens 100 with specified light distribution, negligible glare, and negligible color separation, thereby giving a uniform light distribution, as discussed herein.

Although the features and elements of the present disclosure are described as embodiments in particular combinations, each feature or element can be used alone or in other various combinations within the principles of the present disclosure to the full extent indicated by the broad general meaning of the terms in which the appended claims are expressed. Any variation or replacement made by one of ordinary skill in the related art without departing from the spirit of the present disclosure shall fall within the protection scope of the present disclosure.

What is claimed is:

1. A lens comprising a first surface and an opposing second surface, wherein:
the first surface comprises a plurality of light diffusing features that protrude outwardly from the first surface in a direction away from the second surface, wherein the plurality of light diffusing features is adapted to diffuse light incident on the first surface to create diffused light; and
the second surface comprises a plurality of discrete light shaping features, wherein each discrete light shaping feature comprises a base and a curved surface that curves relative to the first surface and is adapted to receive and shape the diffused light such that a desired light distribution exits the lens.

2. The lens according to claim 1, wherein the curved surface of each of the plurality of discrete light shaping features protrudes outwardly in a direction away from the first surface.

3. The lens according to claim 1, wherein the curved surface of each of the plurality of discrete light shaping features curves inwardly in a direction toward the first surface.

4. The lens according to claim 1, wherein the plurality of discrete light shaping features are arranged on the second surface in a plurality of rings extending around an axis of the lens, with a center of each ring being the lens axis, wherein a first set of discrete light shaping features is arranged along a first ring of the plurality of rings and a second set of discrete light shaping features is arranged along a second ring of the plurality of rings, the first ring having a smaller diameter than the second ring and the second ring being immediately adjacent to the first ring.

5. The lens according to claim 4, wherein a center point of at least one discrete light shaping features of the first set of discrete light shaping features in the first ring is laterally offset from a center point of one or more radially adjacent light shaping features of the second set of discrete light shaping features in the second ring.

6. The lens according to claim 1, wherein the base has at least one of: a trapezoidal shape, a rectangular shape, a square shape, a regular polygonal shape, a circular shape, or an oval shape.

7. The lens according to claim 1, wherein the curved surface of each of the plurality of discrete light shaping features has a freeform shape configured to create the desired light distribution, wherein the desired light distribution is a function of a degree of curvature of the freeform shape.

8. The lens according to claim 1, wherein the base of each of the plurality of discrete light shaping features overlies three or more of the plurality of light diffusing features.

9. The lens according to claim 1, wherein the plurality of light diffusing features is arranged on the first surface in a matrix manner, wherein adjacent rows of light diffusing features of the plurality of light diffusing features in the matrix abut against each other, and adjacent light diffusing features in the same row abut against each other, and wherein a total area covered by the plurality of light diffusing features is substantially the same as a total area covered by the plurality of discrete light shaping features arranged on the second surface.

10. The lens according to claim 9, wherein the plurality of light diffusing features comprises a light-entering surface having textured features adapted to protrude towards one or more light sources.

11. The lens according to claim 10, wherein the textured features of the light-entering surface on the first surface comprises at least one of: a curved shape, a diamond shape, a prismatic shape, or knurling texture.

12. A luminaire comprising:
a light board comprising a plurality of light sources; and
a lens optically coupled to the light board, the lens comprising:
a first surface facing the light board and comprising a plurality of light diffusing features protruding towards the light board, wherein the plurality of light diffusing features is adapted to diffuse light received from the plurality of light sources; and
a second surface opposite to the first surface and facing away from the light board, the second surface comprising a plurality of discrete light shaping features, wherein each discrete light shaping feature comprises a base and a surface that curves relative to the first surface, and is adapted to shape the diffused light such that the diffused light exits the lens in a desired distribution.

13. The luminaire according to claim 12, wherein the curved surface of each of the plurality of discrete light shaping features protrudes outwardly from the base in a direction away from the first surface; or
wherein the curved surface of each of the plurality of discrete light shaping features curves inwardly in a direction toward the first surface.

14. The luminaire according to claim 12, wherein the plurality of discrete light shaping features are arranged on the second surface in a plurality of rings around an axis of the lens.

15. The luminaire according to claim 14, wherein a center point of at least one discrete light shaping feature in a first ring of the plurality of ring is laterally offset from a center point of one or more radially adjacent light shaping features in a second ring of the plurality of ring.

16. The luminaire according to claim 12, wherein the plurality of light diffusing features is arranged on the first surface in a matrix manner such that adjacent rows of light diffusing features of the plurality of light diffusing features in the matrix abut against each other and adjacent light diffusing features in the same row abut against each other.

17. The luminaire according to claim 12, wherein a total area occupied on the first surface of the lens by the plurality of light diffusing features is substantially the same as a total area occupied on the second surface of the lens by the plurality of discrete light shaping features.

18. The luminaire according to claim 12, wherein the plurality of light sources are light emitting diodes (LEDs), wherein the LEDs are arranged on the light board in LED sections, and wherein adjacent LED sections are separated by a gap.

19. The luminaire according to claim 18, wherein each of the plurality of discrete light shaping features overlies only one light source.

20. The luminaire according to claim 19, wherein each light discrete light shaping feature overlies at least three of the plurality of light diffusing features.
